(19) United States
(12) Patent Application Publication
(10) Pub. No.: US 2020/0169193 A1
(43) Pub. Date: May 28, 2020

(54) AN ACCESSORY SYSTEM AND A METHOD OF POWERING AN ACCESSORY

(71) Applicant: PHILIPS LIGHTING HOLDING B.V., EINDHOVEN (NL)

(72) Inventor: Oscar GARCIA MARCHON, EINDHOVEN (NL)

(21) Appl. No.: 16/061,884

(22) PCT Filed: Dec. 15, 2016
(86) PCT No.: PCT/EP2016/081247

§ 371 Date: Jun. 13, 2018

(30) Foreign Application Priority Data
Dec. 17, 2015 (EP) 15200839.7

(51) Int. Cl. H02N 2/18

(52) U.S. Cl. CPC H02N 2/186; H02K 35/06; H02N 2/181

(57) ABSTRACT

An accessory system comprises an accessory unit adapted to be attached to a structure. The accessory unit comprises an accessory, such as a sensor, for attaching to a structure, and a vibration energy harvesting device. The vibrational energy harvesting device is arranged to contact the structure in use, and powers the accessory unit by converting vibrations transmitted through the structure to electrical energy.

### FIELD OF THE INVENTION

This invention relates to an accessory system and a method of powering an accessory, and in particular to an accessory for mounting to a structure without the need for a wired power supply. The invention for example relates to a sensor or an advertising display.

### BACKGROUND OF THE INVENTION

It is becoming increasingly popular to provide structures, such as street lamps, traffic lights, buildings and bridges etc., with accessories such as sensors or displays. In this way, a variety of different services can be provided, such as smart sensing, security and advertisement. For example, a movement sensor may be attached to the street lamp to detect whether a person is present in the vicinity of the streetlamp and thus whether lighting is required.

In general, the accessory is mounted to a structure and connected to a power supply. However, the structure may have a limited number of locations that provide access to the power supply, which may determine where the accessory can be mounted. For example, street lamps are supplied with power using underground wiring connected to a utility post of the electrical grid. The power supply cabling is routed through a stem (post) of the street lamp to a light source supported by the stem.

FIG. 1 shows a conventional street lamp 1, including a stem 2 and a light source 4 attached to the stem 2. A connection box 6 is provided within the stem 2, for connecting the street lamp 1 to the underground wiring.

The accessory can only be directly connected to the power supply of the lighting device at the connection box 6, or inside the light source 4 and therefore the choice of location is limited. Another option is to connect the accessory to the power supply by creating a hole in the stem of the street lamp, and connect a cable between the accessory and the power supply of the street lamp. This increases the choice of location but may make the accessory inconvenient and expensive to install. Another proposal is to use solar panels to power the accessory; however this is relatively expensive and can be unreliable.

There is therefore a need for an alternative way to power an accessory.

### SUMMARY OF THE INVENTION

The invention is defined by the claims.

According to examples in accordance with an aspect of the invention, there is provided an accessory system, comprising an accessory unit adapted to be attached to a structure, the accessory unit comprising:

an accessory; and

a vibration energy harvesting device for powering the accessory and arranged to contact the structure, in use.

The accessory unit can be attached to a structure, such as a lighting device, a barrier, a building or a bridge. The accessory is powered by the vibration energy harvesting device, which receives vibrations transmitted through the structure and converts the vibrations to electrical energy. In this way, the accessory unit can be attached to the structure at any location, without being restricted by the need to be connected to a power supply of the structure. The accessory is a device which is electrically powered, such as a sensor or display.

The accessory system may further comprise a vibrator for transmitting a vibration along the structure.

The vibration energy harvesting device may convert vibrations of the structure, including vibrations generated by the vibrator as well as vibrations from the surrounding environment, into electrical energy. The vibrator may be directly connected to a power supply associated with the structure, and mechanically coupled to the structure. The vibrator may transmit energy from the power supply to the vibration energy harvesting device through the structure. By providing this arrangement, the accessory unit can be positioned anywhere along the stem of the lighting device, without being restricted to locations in which the power supply is accessible.

The structure may be a lighting device comprising a stem such as a pole, and the vibration energy harvesting device may be adapted to contact the stem in use.

A lighting device may be provided, which comprises a light source and a stem, wherein the light source is attached to one end of the stem. The other end of the stem contains a connection unit for connecting the light source to a power supply. In this way, power is supplied to the lighting device.

In use, the accessory unit is attached to a stem of the lighting device. The accessory unit includes an accessory, such as a sensor for measuring parameters relating to an external environment; for example, a light sensor for measuring ambient lighting or a motion sensor for detecting the presence of a person. The accessory unit also comprises a vibration energy harvesting device, which contacts the stem of the lighting device. The vibration energy harvesting device is configured to convert vibrations transmitted along the stem of the lighting device to electrical energy and to direct this energy to the accessory, in order to power it.

The accessory system may further comprise a controller configured to:

adjust a resonant frequency of the vibration energy harvesting device; and

adjust a vibration frequency of the vibrator.

In this case, the accessory unit may comprise a tuner for adjusting the resonant frequency of the vibration energy harvesting device. By providing this feature, the accessory unit can be efficiently powered. The vibrator can be controlled to vibrate at a frequency that is most efficiently transferred along or through the structure and the vibration energy harvesting device can be adjusted to set this frequency as its resonant frequency, enabling effective conversion of mechanical energy into electrical energy.

The controller may be configured to adjust the resonant frequency of the vibration energy harvesting device and the vibration frequency of the vibrator automatically. The most efficient frequency may be unknown at the time of manufacture of the accessory system, or may change over time. By providing automatic selection of the most efficient frequency for transmission along the stem, the accessory system may be highly efficient.

The controller may be configured to control the accessory to perform a frequency selection procedure, comprising:

generating a plurality of vibrations within a vibration frequency range;

measuring the energy generated at each vibration frequency;

detecting a peak in the generated energy and determining a corresponding peak vibration frequency associated with the peak energy;

generating vibrations at the peak vibration frequency; and

adjusting the resonant frequency of the vibration energy harvesting device to the peak vibration energy.

The controller may control the vibrator to generate vibrations of different frequencies, and may measure the energy produced by the vibration harvesting energy device at different frequencies. The controller may determine at which frequency the most energy is produced by the vibration harvesting energy device and may control the vibrator to vibrate at the identified frequency, and may adjust the resonant frequency of the vibration harvesting energy device to be this same frequency.

The vibrator and the vibration energy harvesting device may be adapted to communicate with each other. The vibrator and the vibration energy harvesting device may each comprise a wireless radio for transmitting and/or receiving information. Alternatively, or additionally, the vibration energy harvesting device may be adapted to transmit and/or receive information based on generating and detecting vibrations.

The accessory system may further comprise:

an energy storage device for storing energy generated by the vibration energy harvesting device, wherein the controller is configured to:

determine whether the energy stored in the energy storage member is equal to or greater than a threshold energy value;

if the amount of stored energy is equal to or greater than the threshold energy value, send a first control signal to the vibrator, instructing the vibrator to stop vibrating for a time; and

if the amount of stored energy is not equal to or greater than the threshold energy value, send a second control signal, instructing the vibrator to generate vibrations with increased amplitude.

The controller may be configured to control the vibrator to vibrate at fixed time intervals. In this case, the controller may obtain feedback information about the duration of vibrations and vibration frequency required.

The accessory system may further comprise:

a rectifier for converting an analogue signal of the vibration energy harvesting device to a DC signal, wherein the rectifier is configured to send a raw analogue signal to the controller, and

wherein the controller is configured to receive the analogue signal and to generate a digital data signal based on the analogue signal.

In this way the vibration energy harvesting device can receive configuration parameters for the controller. The rectifier may send the raw analogue signal directly to the controller. Alternatively the raw analogue signal may be transmitted via at least one intermediate device, such as a resistor. In this case, the controller may receive a processed version of the raw analogue signal from the rectifier (via the intermediate device).

The accessory system may further comprise an electro-magnet and a permanent magnet arranged to contact a portion of the vibration energy harvesting device. This enables the accessory also to generate vibrations, and these may be used for communications purposes.

The controller may create a control signal at a control frequency, which causes the electro-magnet to exert a changing magnetic field, and accordingly a changing force on the magnet, causing the magnet to oscillate in space. The amplitude of the magnet oscillations can be adjusted, such that oscillation of the magnet results in the magnet exerting a force on the vibration energy harvesting device, creating a vibration that is transmitted by the vibration energy harvesting device along the stem of the lighting device.

According to another aspect of the invention, there is provided a method of powering an accessory, wherein the accessory is attached to a structure, the method comprising:

generating vibrations with a vibrator;

transmitting the vibrations from the vibrator along the stem to a vibration energy harvesting device; and

converting the vibrations to electrical energy for powering the accessory.

Vibrations are generated with a vibrator connected to a power supply. By transmitting the vibrations along the structure to the vibration harvesting device, which converts the vibrations to electrical energy, it is possible to generate energy at a location on the structure that is remote to the power supply. The vibrations may be used to power more than one accessory device.

The method may further comprise:

generating vibrations over a range of frequencies;

measuring the energy generated at each vibration frequency;

detecting a peak energy and determining the vibration frequency (the peak vibration frequency) associated with the peak energy;

generating vibrations at the peak vibration frequency; and

adjusting the resonant frequency of the vibration energy harvesting device to the peak vibration energy.

The method may further comprise receiving an analogue signal from a rectifier and converting the analogue into a digital data signal.

In this way, vibrations can be used not only to power the accessory, but also to communicate with the accessory. The analogue signal may be received directly from the rectifier, or may be received after the signal has passed through other components, such as components for limiting current (e.g. resistors, diodes etc.).

The method may further comprise transmitting a vibration from the vibration energy harvesting device to the vibrator, and detecting the vibration to generate a digital signal.

In this way, vibrations can also be used to transmit information from the accessory to a receiver, for example a remote controller.

### BRIEF DESCRIPTION OF THE DRAWINGS

Examples of the invention will now be described in detail with reference to the accompanying drawings, in which:

FIG. 1 shows a conventional street lamp;

FIG. 2 shows an accessory system according to an example;

FIG. 3 shows an accessory system according to another example;

FIG. 4 illustrates a frequency selection procedure according to an example;

FIG. 5 illustrates the operation of a vibrator, according to an example;

FIG. 6A is a block diagram or a system of an accessory unit, according to an example;

FIG. 6B is a circuit diagram for an accessory unit according to an example;

FIG. 7 is a block diagram of an accessory unit, according to an example;

FIG. 8 is a circuit diagram, for an accessory unit according to an example;

FIG. 9 shows an accessory system according to an example;

FIG. 10 illustrates an accessory unit according to an example; and

FIG. 11 is a block diagram of an accessory unit, according to an example.

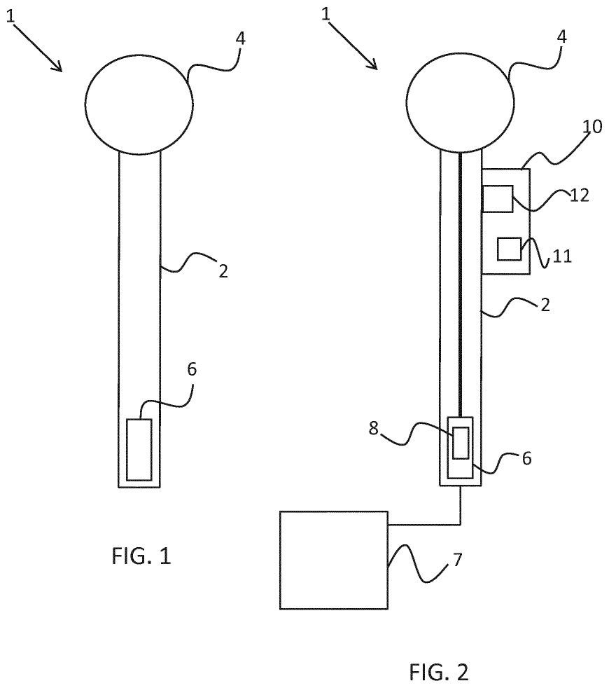

### DETAILED DESCRIPTION OF THE EMBODIMENTS

The invention provides an accessory system comprising an accessory unit which is adapted to be attached to a structure. The accessory unit comprises an accessory, such as a sensor, and a vibration energy harvesting device, which is mechanically coupled to the structure. In use, the vibration energy harvesting device converts vibrations transmitted along the structure into electrical energy in order to power the accessory. In this way, the accessory is remotely powered by the vibration energy harvesting device and it is therefore possible to avoid directly connecting the accessory to the power supply of the structure. Therefore, the accessory can be mounted at any location on the structure, and is not limited to locations where the power supply of the structure can be directly accessed.

FIG. 2 shows a schematic diagram of an accessory system according to an example. In this example, the accessory system is attached to a structure in the form of a lighting device 1 which comprises a stem 2 and a light source 4 attached to one end of the stem 2. A connection box 6, for connecting the lighting device to a power supply 7, e.g. an electrical grid, is provided at a base of the stem 2. The accessory system further comprises a vibrator 8 which is mounted to the lighting device, inside the connection box, and is electrically coupled to a power supply 7 and mechanically coupled to the stem to allow the vibration from the vibrator to be inserted in the mechanical structure of the stem. An accessory unit 10 comprising an accessory 11 (such as a sensor or a visual display unit) and a vibration energy harvesting device 12 is attached to the stem, for example clamped, bolted or strapped to the stem.

The vibrator 8 is arranged to transmit vibrations along the stem 2 of the lighting device to the accessory unit 10 comprising the vibration energy harvesting device 12. Thus, by transmitting vibrations along the stem 2 of the lighting device 1 to a vibration energy harvesting device 12, it is possible to power the accessory at any location on the stem 2. In particular, the accessory unit 10 can be provided on an exterior of the stem 2, rather than inside the stem (where the power supply is directly accessible). Since the accessory unit 10 is not directly connected to the power supply 7, there is no need to provide a hole in the stem 2 to access the power supply, nor is it necessary to provide additional cabling.

In use, the vibrator 8 is powered by electricity supplied by the electrical grid. The vibration energy harvesting device 12 converts mechanical energy from vibrations, which propagate along the stem, into electrical energy.

The accessory unit 10 and the stem 2 are closely mechanically coupled to facilitate good transmission of vibrations generated by the vibrator 8 through the stem structure to the accessory unit 10 and the vibration energy harvesting device 12. The vibration energy harvesting device is arranged within the accessory unit in such a way that it is mechanically coupled to the stem when the accessory unit is mounted to the stem. For example, the vibration energy harvesting device 12 may be arranged to be in direct contact with the stem 2. Alternatively, the vibration harvesting energy device 12 may be coupled to the stem 2 by an intermediate member.

The vibration energy harvesting device 12 may also convert vibrations from the external environment, for example due to wind or traffic, into electrical energy.

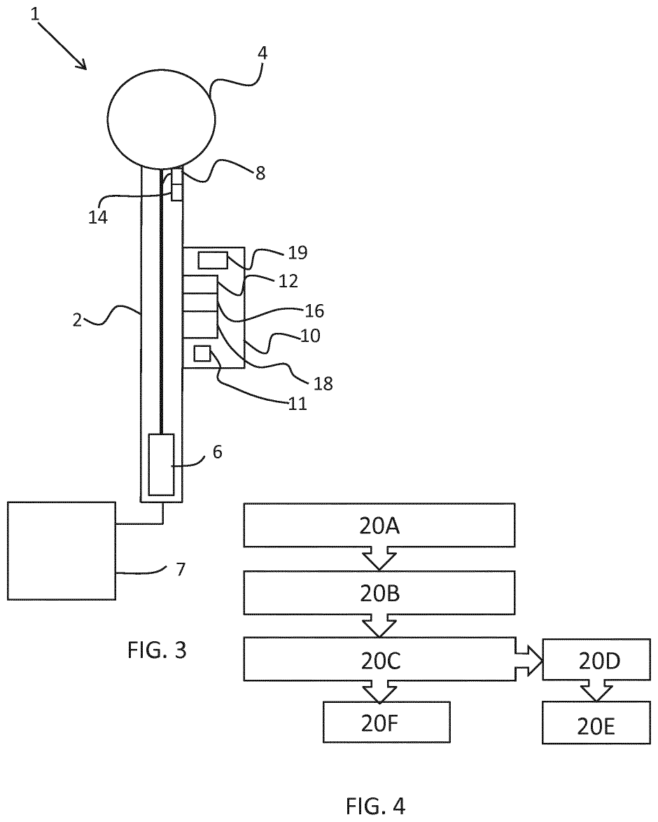

FIG. 3 shows an arrangement in which the vibrator 8 is located at the same end of the stem 2 of the lighting device 1 as the light source 4. The vibrator 8 is electrically coupled to the power supply 7, e.g. via connection box 6, and is therefore positioned inside the stem 2. In order to effectively transmit vibrations along the stem 2, the vibrator is attached to the stem. The vibrator may, for example, be a piezoelectric device, such as a piezoelectric buzzer. The vibration amplitude and frequency of the vibrator can be adjusted; for example, the apparatus may include a relay for controlling the vibrator to operate at the required frequency and voltage.

The vibrator comprises a communication unit 14 for sending signals to the vibration energy harvesting device 12, and receiving signals from the vibration energy harvesting device 12. The accessory unit 10 also comprises a communication unit 16 for sending signals to the vibrator 8, and receiving signals from the vibrator 8. In an example, the communication units 14, 16 comprise a wireless radio for transmitting and/or receiving wireless signals.

The vibration energy harvesting device may be an electromagnetic vibration energy harvesting device, a piezoelectric vibration energy harvesting device, a triboelectric vibration energy harvesting device, a magnetostrictive vibration harvesting energy device or any other type of vibration harvesting energy device.

For example, the vibration energy harvesting device is a piezoelectric device. In this example, the vibration energy harvesting device comprises piezoelectric material. Piezoelectric material becomes charged when subject to mechanical stress. The piezoelectric material is coupled to the stem such that vibrations transmitted through the stem to the piezoelectric material apply mechanical stress to the piezoelectric material, which generates electricity in response.

In another example, the vibration harvesting energy device is a triboelectric device. Triboelectric energy generation is a contact-induced electrification in which a material becomes electrically charged after it is contacted with a different material, through friction. Triboelectric generation is based on converting mechanical energy into electrical energy through methods which couple the triboelectric effect with electrostatic induction. The device comprises two triboelectric layers which are brought into contact and separated by the vibrations generated by the vibrator. When the layers are brought into contact, a charge is built up on each layer (of differing polarity), due to the triboelectric effect. The layers are subsequently separated, and an electrical potential builds up between them. If electrodes are attached to the triboelectric layers, with an electrical load between them, further separation of the layers results in a current flow between the two electrodes.

The vibration is then arranged to induce the desired electrode movement to generate current by the triboelectric effect.

The vibration energy harvesting device 12 is configured to absorb energy most efficiently at a first resonant frequency (f1). For effective power generation, the optimal frequency of vibration or an optimal set of vibration frequencies is determined. This is the frequency (or frequencies) at which the most power is generated by the vibration energy harvesting device 12 in response to vibration transmitted along the stem 2 of a lighting device to which the accessory unit 10 is mounted. In general, when the accessory unit 10 is manufactured, information about the stem of the lighting device 1 to which the accessory unit 10 is to be mounted and the location at which the accessory unit will be mounted is unknown. Therefore, the frequency or set of frequencies that are effectively transmitted by the stem 2 is unknown. Also, the optimal transmission frequency may change over time as a result of, for example, damage to the lighting device 1 or accessory unit 10.

To determine the optimal frequency of vibration, the following parameters may be taken into account:

a set of frequencies (f3) that are well transferred over the stem due to the specific stem construction and its materials and which do not include the resonant frequency of the lighting device;

the resonant frequency of the lighting device due to the height of the stem, and taking account of the height and weight of the accessory system (f4); and

the resonant frequency for the transfer of vibrations from the road to the stem due to external factors e.g. features of the road, etc. (f5).

It is important to take into account not only the frequencies of the vibrator (f2) and vibration energy harvesting device (f1) but also the frequencies that ensure a good transfer of energy from the vibrator to the vibration energy harvesting device (f3), and those which allow a good absorption of energy from the environment (f5). Further, the vibration frequency (f2) should not be the resonant frequency of the lighting device (f4), since operating the vibrator at the resonant frequency of the lighting device would likely damage the lighting device.

The frequency of the vibrator 8 may be manually adjusted to determine the optimal vibration frequency, by fitting the resonant frequency of the vibration energy harvesting device and the vibration frequency of the vibrator to a frequency within the set of frequencies that are well transferred by the stem 2.

Alternatively, the accessory system may comprise a controller configured to carry out a frequency selection procedure by automatically adjusting the frequency of the vibrator to an optimal frequency for vibrational energy harvesting by adjusting the resonant frequency of the vibration harvesting energy device and the vibrator based on the frequencies that are most effectively transferred by the stem of the lighting device. In this case, the accessory unit 10 comprises a tuner for tuning the resonant frequency of the vibration energy harvesting device. The tuner may be a mechanical device which alters the resonant frequency by changing a mechanical property of the vibration energy harvesting device. Alternatively, the device may be adapted to change the resonant frequency of the vibration energy harvesting device by adjusting an electrical load.

The accessory unit 10 comprises a controller 18. The controller 18 may be a single control unit, or may comprise a plurality of control units that are configured to communicate with each other. The controller 18 is configured to control the accessory unit 10 to adjust a resonant frequency of the vibration energy harvesting device 12. The controller 18 is also configured to control the accessory unit 10 to send communication signals to the vibrator 8 via the communication unit 16.

The vibrator 8 is adapted to generate vibrations over a range of frequencies. The controller 18 is configured to control the vibrator 8 to adjust the vibration frequency (f2) generated by the vibrator 8 and to receive signals from the vibration energy harvesting device via the communication unit 14.

The accessory unit 10 also comprises an energy storage device 19 arranged to store energy generated by the vibration energy harvesting device, and to supply the accessory 11 with the stored energy. During operation, the vibration energy harvesting device 12 may harvest and store enough energy to operate the accessory unit 10, including the accessory 11. In this situation, the vibration energy harvesting device 12 can communicate with the vibrator 8 via their respective communication units, to instruct the vibrator 8 to stop vibrating for a given period of time.

If more vibrations are required to keep powering the vibration energy harvesting device 12, then the vibration energy harvesting device 12 can also communicate this to the vibrator 8. Alternatively, the vibrator can include a configuration in which it vibrates a given percentage of the time.

The accessory unit 10 may have very specific patterns for energy consumption. For example, if the accessory unit 10 comprises a sensor 11, it may be configured to perform sensing for short bursts of time and send a message over longer time intervals (e.g. sensing every five minutes and sending a message every hour). In this case, the vibrator can be controlled to generate vibration patterns corresponding to the pattern of energy consumption of the sensor 11.

FIG. 4 illustrates the frequency selection procedure performed by the controller for the device of FIG. 3. The frequency selection procedure is performed to maximize the energy transfer from the vibrator 8 to the vibration energy harvesting device 12 through the stem 2.

In Step 20A, the resonant frequency of the vibration energy harvesting device is set at an initial frequency. This may be the resonant frequency of the vibration energy harvesting device determined during manufacture. Alternatively, the controller may be configured to calculate an initial resonant frequency that is likely to be optimal based on values for parameters relating to the lighting device to which the accessory unit is mounted, input by a user.

In Step 20B, the vibrator generates a sequence of vibrations over a range of vibration frequencies. For example, the frequency range may be from 50 Hz to 150 Hz, and preferably frequencies around 100 Hz.

In Step 20C, the vibration energy harvesting device measures the energy produced at each frequency within the range, and detects a peak energy which corresponds to a peak frequency.

In Step 20D, the vibration energy harvesting device communicates the peak frequency to the vibrator. The controller is configured to control the vibration energy harvesting device to send a signal to the vibrator via the communication unit.

In Step 20E, the vibrator generates vibrations at the peak frequency. The vibrator receives a signal via its communication unit from the vibration energy harvesting device indicating the peak frequency as determined by the vibration energy harvesting device. A controller controls the vibrator to adjust the vibration frequency accordingly.

In Step 20F, the vibration energy harvesting device sets its resonant frequency at the peak frequency. The controller controls the tuner to adjust the resonant frequency of the vibration energy harvesting device.

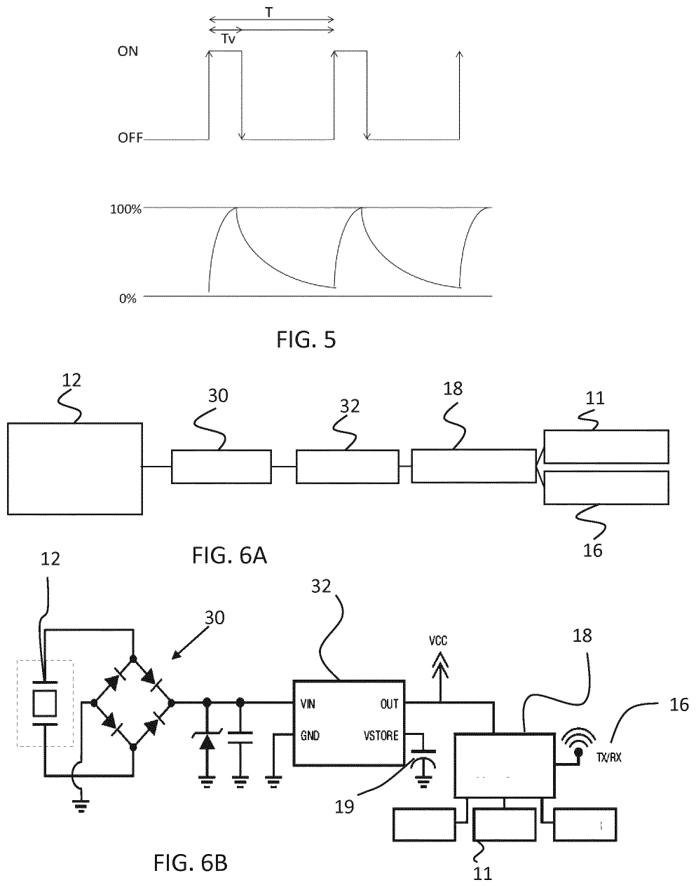

FIG. 5 illustrates the operation of the vibrator according to an example. The diagram shows an operation mode in which the vibrator is controller to vibrate for a short period (Tv), so that the vibrator is on for a fraction (Tv/T) of the total operation time (T).

The upper figure shows whether the vibrator is “on” or “off”, and the lower diagram shows the percentage of energy stored by the energy storage device.

After a time period Tv, the controller may determine that enough energy is stored in the energy storage device to operate the accessory, and communicates this to the vibrator, which pauses vibration. After a time period T-Tv passes, the vibrator is re-started to replete the energy storage device. Alternatively, the controller 18 may control the vibrator according to a known pattern of energy consumption of the accessory.

In an alternative operation mode, during the period Tv the battery of the vibration energy harvesting device is charged and during that time the accessory runs on a secondary energy source (e.g. batteries).

FIG. 6A shows a block diagram for a system according to an example. The vibration energy harvesting device 12 is connected to a rectifier 30 for converting the analogue input from the vibration energy harvesting device 12 into direct current. The DC current is directed to a charge management device 32 for regulating charging of the energy storage device. The vibration energy harvesting device 12 is also connected to a microcontroller 18, which is configured to control a number of sensors 11 and a wireless radio 16.

FIG. 6B shows an example circuit diagram for the system shown in FIG. 6A. It additionally shows the energy storage element 19 controlled by the charge management device 32.

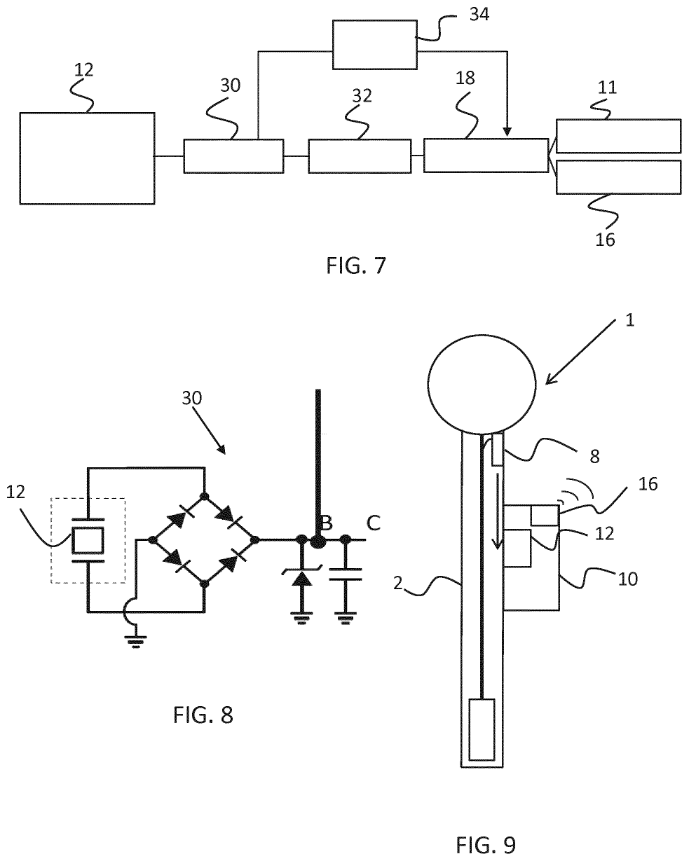

FIG. 7 shows a block diagram of an accessory unit 10 which is adapted to enable both power effective and cost effective communication, since the accessory unit is configured to receive data via the vibration energy harvesting device. The system comprises a rectifier 30, a charge management device 32 and a microcontroller 18 which controls a sensor 11 and a communication unit 16.

To receive data, the vibration energy harvesting device 12 converts vibrations into an electrical signal which is converted into digital data. In this way, the accessory unit 10 can receive configuration parameters for the microcontroller 18.

The rectifier 30 directs an analogue signal from the vibration energy harvesting device 12 to the microcontroller 18. The raw analogue input signal is measured during the rectification, before rectification is complete (before the signal is converted to DC), so that the voltage still changes according to the input vibration in the vibration energy harvesting device.

The analogue current signal is directed to the microcontroller via circuit 34 which adapts the signal so that it can be used as an input to the microcontroller. For example, the circuit 34 comprises a resistor arrangement.

With this arrangement, if a vibration is received at the vibration energy harvesting device 12 at time t, then it will create a positive voltage V which can be read from the analogue signal. If then the vibration disappears, then the voltage will go down to zero. As shown in FIG. 7, the analogue input is connected to an input pin of the microcontroller 18 able to detect the values (V or 0 volts).

By superposing a higher frequency vibration signal over a lower frequency carrier, the carrier may be used to transmit data. The carrier signal can then be translated to binary zeros and ones. The microcontroller 18 may also comprise a counter for tracking the number and sequence of zeros and ones in a given period of time. In this way, a data signal may be transmitted to the energy harvester using modulation of vibrations generated by the vibrator.

In this example, the accessory is powered by the vibration energy harvesting device and may also receive signals via the same vibration energy harvesting device. In alternative examples, the functions of powering the accessory and receiving data are shared between two vibration energy harvesting devices; one of the vibration energy harvesting devices is arranged to power the accessory and the other is arranged to receive data. If the vibration energy harvesting device is arranged only to power the accessory and not to transmit data, the circuit 34 may be excluded.

FIG. 8 shows an example circuit diagram for the accessory unit of FIG. 7. The rectifier 30 is shown as a full bridge rectifier, and a blocking diode and smoothing capacitor are at the output of the rectifier 30. At point B, where the signal fluctuates according to the vibration detected by the vibration energy harvesting device 12, an analogue current signal generated by the vibration energy harvesting device 12 is processed to create a voltage that is dependent on the analogue current signal at point B. This may be achieved using a resistor arrangement. The voltage is for example provided to an A/D input of a microcontroller. At point C, the signal has passed through the capacitor, and is therefore relatively stable.

To enable transmission of data from the accessory unit rather than reception by the accessory unit, the accessory unit may comprise a wireless radio 16 as shown in FIG. 7. If transmission of data is not required, the wireless radio can be excluded. Since the wireless radio need only be used for the transmission of data and not for reception, the accessory unit is energy efficient since (a) less energy is required for transmission than for transmission and reception and (b) the wireless radio is only activated when the device is transmitting data. This arrangement is shown in FIG. 9, in which the wireless radio is configured to only transmit data, and not to receive it.

FIG. 9 illustrates a lighting device 1 and an accessory system according to an example, in which a downlink is provided by receiving data via the vibration energy harvesting device and an uplink is provided with the wireless radio 16. In other words, the vibrator 8 can transmit information to the vibration energy harvesting device 12 by transmitting vibrations along the stem 2 of the lighting device, and the accessory unit 10 containing the vibration energy harvesting device 12 can communicate with the vibrator 8 over a wireless network.

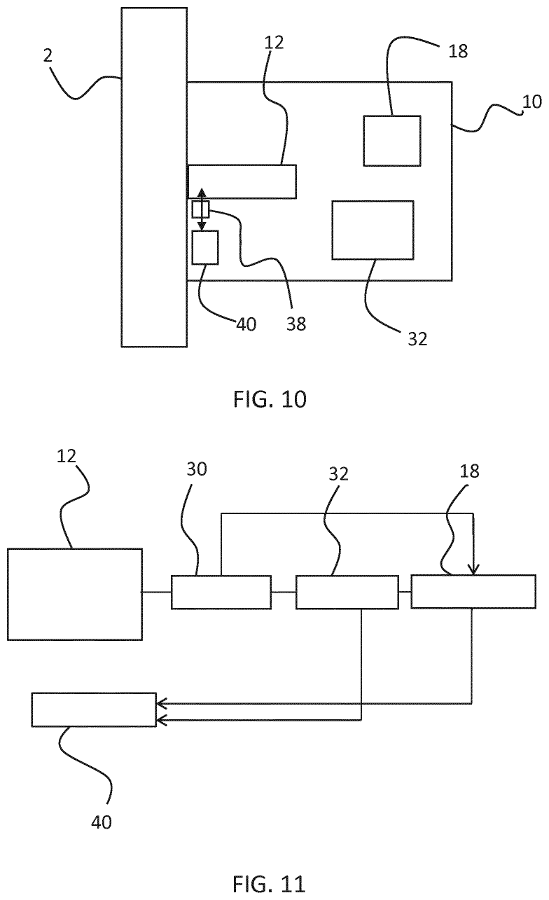

FIG. 10 illustrates an accessory unit 10 according to an example, which is adapted to provide both transmission and reception of data using vibrations. In use, a portion of the vibration energy harvesting device 12 vibrates in response to the vibrations transmitted along the stem of the lighting device from the vibrator. The vibrating portion of the vibration energy harvesting device 12 is also used to create further vibrations, for transmitting data to the vibrator. FIG. 10 also shows the microcontroller 18 and charge management device 32.

The accessory unit comprises a small magnet 38, attached to an end of the vibrating portion of the vibration energy harvesting device, and an electromagnet 40. The electromagnet 40 is connected to the charge management device, and is powered by the vibration energy harvesting device 12. An AC current is applied to the electromagnet 40, causing the electromagnet to attract and repel the small magnet, as the polarity of the electromagnet changes. By adjusting the amplitude of this signal, the magnet will hit a solid part (such as the stem of the lighting device, or a wall of the accessory unit) creating a vibration. The vibration generated by the magnet is transmitted along the stem to the vibrator.

In an example, the magnet 38 and electromagnet 40 are arranged such that the magnet is moved by the electromagnet 40 to hit a part of the stem 2 of the lighting device when the accessory unit 10 is mounted to the lighting device. The magnet may be arranged to directly hit the stem 2, or may hit another part of the accessory unit 10 which is in contact with the stem 2.

In another example, the magnet 38 is directly attached to the stem 2 and the electromagnet 40 moves according to the AC frequency. The electromagnet hits the magnet 38, which transmits the generated impact to the stem 2.

In both cases, the stem 2 is hit at a frequency equal to a control signal of the microcontroller. The control signal provides a carrier signal for vibrations generated by the magnet and electromagnet arrangement. The vibrator 8 measures the frequency of a vibration detected over a detection period. The period of the vibration is equal to the period of the carrier signal. The detection period is the time assigned to each symbol. For each detection period, if the vibrations are transmitted at a frequency equal to the control signal, a “1” is generated, or if the control frequency is not detected a “0” is generated. Therefore, the transmission frequency (the number of symbols transmitted per second) is lower than the carrier frequency. Over a given period, T, in which there is a continuous carrier signal, T/Td symbols are recorded where Td is the detection period (the period of a symbol).

FIG. 11 shows a schematic arrangement of the accessory unit of FIG. 10. As above, the rectifier 30 sends an analogue signal to the controller 18, which interprets the signal to receive data via vibrations detected by the vibration energy harvesting device 12. The electromagnet 40 is charged by the vibration energy harvesting device 12 via the charge management device 32. The controller sends a control signal to the electromagnet, creating a changing magnetic field.

The accessory may be a sensor unit for measuring parameters relating to an external environment, for example a light sensor for measuring ambient lighting or a motion sensor for detecting the presence of a person. The sensor unit may comprise a display for displaying an advertisement or other information to a passer-by.

As explained above, the system may incorporate a vibrator for transmitting vibrations to the structure. This enables the timing of the energy transfer to be controlled and it also enables communication to be carried out by modulating the vibrations using a communications signal. However, the system may instead harvest vibrational energy from natural vibrations, for example caused by the wind or by vibrations transmitted through the ground. The higher up the stem that the accessory is mounted, the greater these vibrations are likely to be. If these natural vibrations are sufficient to power the accessory, when the energy harvested is averaged using an energy storage system, then no additional vibration source may be needed.

The system may comprise a plurality of vibration energy harvesting devices. The vibration energy harvesting devices may be arranged to power the accessory, or each device may be arranged to power different components of the accessory. In the example described above (FIG. 7), the accessory is powered by the vibration energy harvesting device and may also receive signals via the same vibration energy harvesting device. In alternative examples, the functions of powering the accessory and receiving data are shared between two vibration energy harvesting devices; one of the vibration energy harvesting devices is arranged to power the accessory and the other is arranged to receive data.

The accessory may be adapted to communicate with other devices, for example other accessories. Multiple accessories may communicate simultaneously. Communication between devices would require a medium-access control layer to avoid collisions when transmitting and receiving information. Multiple devices may communicate at the same time by using device specific communication frequencies. In this case, the accessory may be configured to adjust the resonant frequency of the vibration energy harvesting device according to a designated communication frequency.

The examples described above are with reference to a street lamp. However, the invention may be used with other types of structure. For example, the accessory system may be used with a signaling device, such as traffic lights, with poles supporting advertising boards, with road barriers, with utility pipes, such as gas or water pipes. The invention may be implemented with buildings, or other types of structures such as bridges. The invention may be suitable for use with a vehicle, for example a train. The invention may be particularly useful in cases where sensors are used to monitor the environment over long time periods.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An accessory system, comprising an accessory unit adapted to be attached to a structure, the accessory unit comprising:
an accessory; and
a vibration energy harvesting device for powering the accessory and arranged to contact the structure, in use,
the accessory system further comprising a vibrator for transmitting a vibration along the structure, in use.

2. The accessory system of claim 1 wherein the vibrator and the vibration energy harvesting device are adapted to communicate with each other.

3. The accessory system of claim 1, wherein the structure is a lighting device comprising a stem, and the vibration energy harvesting device is arranged to contact the stem in use.

4. The accessory system of claim 1, further comprising a controller configured to:
adjust a resonant frequency of the vibration energy harvesting device, and
adjust a vibration frequency of the vibrator.

5. The accessory system of claim 4 wherein the controller is configured to adjust the resonant frequency of the vibration energy harvesting device and the vibration frequency of the vibrator automatically.

6. The accessory system of claim 5 wherein the controller is configured to control the accessory unit to perform a frequency selection procedure, comprising:
generating vibrations over a range of frequencies;
measuring the energy generated at each vibration frequency;
detecting a peak in the generated energy and determining a corresponding peak vibration frequency associated with the peak energy;
generating vibrations at the peak vibration frequency; and
adjusting the resonant frequency of the vibration energy harvesting device to the peak vibration energy.

7. The accessory system of claim 4, further comprising an energy storage device for storing energy generated by the vibration energy harvesting device, wherein the controller is configured to:
determine whether the energy stored in the energy storage member is equal to or greater than a threshold energy value;
if the amount of stored energy is equal to or greater than the threshold energy value, send a first control signal to the vibrator, instructing the vibrator to stop vibrating for a time; and
if the amount of stored energy is not equal to or greater than the threshold energy value, send a second control signal to instruct the vibrator to generate vibrations with increased amplitude.

8. The accessory system of claim 4, wherein the controller is configured to control the vibrator to vibrate at fixed time intervals.

9. The accessory system of claim 4, further comprising:
a rectifier for converting an analogue signal of the vibration energy harvesting device to a DC signal, wherein the rectifier is configured to send a raw analogue signal to the controller, and
wherein the controller is configured to receive the analogue signal and to generate a digital data signal based on the analogue signal.

10. The accessory system of claim 1, further comprising an electro-magnet and a permanent magnet arranged to contact a portion of the vibration energy harvesting device.

11. A system comprising the accessory system of claim 1, and a structure for attaching the accessory unit to and for transmitting the vibration from the vibrator to the vibration energy harvesting device.

12. A method of powering an accessory, wherein the accessory is attached to a structure, the method comprising:
generating vibrations with a vibrator;
transmitting the vibrations from the vibrator along the structure to a vibration energy harvesting device; and
converting the vibrations to electrical energy for powering the accessory.

13. The method of claim 12 further comprising:
generating vibrations over a range of frequencies;
measuring the energy generated at each vibration frequency;
detecting a peak energy and determining the vibration frequency associated with the peak energy;
generating vibrations at the peak vibration frequency; and
adjusting the resonant frequency of the vibration energy harvesting device to the peak vibration energy.

14. The method of claim 12, further comprising receiving an analogue rectified signal and converting the analogue rectified signal into a digital data signal.

15. The method of claim 12, further comprising transmitting a vibration from the vibration energy harvesting device to the vibrator, and detecting the vibration to generate a digital signal.
